(19) United States
(12) Patent Application Publication
(10) Pub. No.: US 2010/0267547 A1
(43) Pub. Date: Oct. 21, 2010

(54) Method of producing gas cleaning catalyst unit

(75) Inventor: Hiroaki Yotou, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/798,921

(22) Filed: Apr. 14, 2010

(30) Foreign Application Priority Data
Apr. 16, 2009 (JP) 2009-099685

(51) Int. Cl. B01J 37/34

(52) U.S. Cl. 502/5

(57) ABSTRACT

In a method of producing a gas cleaning catalyst unit, a supporting layer is formed on a surface of a base member. The supporting layer is made of metal oxide. A catalyst slurry is formed by making catalyst component to be suspended in a solvent. The base member having the supporting layer is immersed in the catalyst slurry. Ultrasonic wave is radiated to the base member immersed in the catalyst slurry, such that the catalyst component is supported on the supporting layer.

### CROSS REFERENCE TO RELATED APPLICATION

This application is based on Japanese Patent Application No. 2009-99685 filed on Apr. 16, 2009, the disclosure of which is incorporated herein by reference in its entirety.

### BACKGROUND OF THE INVENTION

1. Field of the Invention The present invention relates to a method of producing a catalyst unit for cleaning gas.

2. Description of Related Art

Precious metal such as Pt, Pd or Rh is used as a catalyst component for cleaning a toxic component such as HC, CO or NOx. The toxic component is contained in gas exhausted from an automobile, for example. The precious metal has a particle state, and is supported on a surface of a honeycomb structure through a supporting member made of alumina, for example. Thus, a contact area between the precious metal and the exhausted gas can be increased.

As emission control for an automobile becomes severe, a cleaning efficiency of a catalyst unit is required to be raised. Similarly, a performance of a catalyst unit is required to be raised, in a fuel-cell field or environment cleaning field. That is, the catalyst unit is developed to have more activity. For example, the particle state of precious metal is made to be finer, thereby a contact area between the metal and toxic component is increased. Thus, the performance of the catalyst unit is raised.

JP-A-2006-21128 discloses a gas cleaning catalyst unit. Catalyst component is contained in powdery porous member made of alumina, and the porous member is dispersed in a slurry. A surface of a honeycomb structure has a dip-coat of the catalyst component by immersing the honeycomb structure in the slurry.

JP-A-2005-125282 discloses a method of coating catalyst component on a supporting member made of metal oxide. The catalyst component can be uniformly coated on the supporting member by using ultrasonic wave.

However, when the catalyst unit is used at a temperature equal to or higher than 950° C., the porous member may be flocculated, and the catalyst component may be buried in the porous member. In this case, a contact area between toxic component and catalyst component is decreased, and catalyst activity is easily lowered.

Further, in a case that the catalyst component is coated b_{y} using ultrasonic wave, the supporting member may be flocculated in a practical environment. In this case, a contact area between toxic component and catalyst component is decreased, and catalyst activity is easily lowered.

### SUMMARY OF THE INVENTION

In view of the foregoing and other problems, it is an object of the present invention to provide a method of producing a gas cleaning catalyst unit.

According to an example of the present invention, in a method of producing a gas cleaning catalyst unit, a supporting layer is formed on a surface of a base member. The supporting layer is made of metal oxide. A catalyst slurry is formed by making catalyst component to be suspended in a solvent. The base member having the supporting layer is immersed in the catalyst slurry. Ultrasonic wave is radiated to the base member immersed in the catalyst slurry, such that the catalyst component is supported on the supporting layer.

Accordingly, cleaning performance of the catalyst unit can be raised.

### BRIEF DESCRIPTION OF THE DRAWINGS

The above and other objects, features and advantages of the present invention will become more apparent from the following detailed description made with reference to the accompanying drawings. In the drawings:

FIG. 1A is a cross-sectional view illustrating a base member of a catalyst unit according to an embodiment, FIG. 1B is a cross-sectional view illustrating a supporting layer of the catalyst unit, and FIG. 1C is a cross-sectional view illustrating catalyst component supported on the supporting layer;

FIG. 2 is a schematic perspective view illustrating the base member;

FIG. 3 is a cross-sectional view illustrating the base member in a direction parallel to an axis of the base member;

FIG. 4 is a view illustrating the base member to be immersed in a support slurry;

FIG. 5 is a view illustrating the base member immersed in a catalyst slurry to which ultrasonic wave is radiated;

FIG. 6A is a view illustrating catalyst component supported on a surface of a supporting particle according to a comparison example, and FIG. 6B is a view illustrating a base member to be immersed in a catalyst slurry of the comparison example;

FIG. 7 is a diagram showing catalyst particle diameters measured in experiments comparing the embodiment and the comparison example;

FIG. 8 is a cross-sectional view illustrating catalyst component supported inside of a supporting layer of the comparison example;

FIG. 9A is a microscopic view illustrating catalyst particle supported on a surface of the supporting layer of the embodiment, FIG. 9B is an enlarged image view of FIG. 9A, and FIG. 9C is an explanatory drawing of FIG. 9B; and

FIG. 10 is a diagram showing cleaning temperatures measured in experiments comparing the embodiment and the comparison example.

### DETAILED DESCRIPTION OF PREFERRED EMBODIMENT

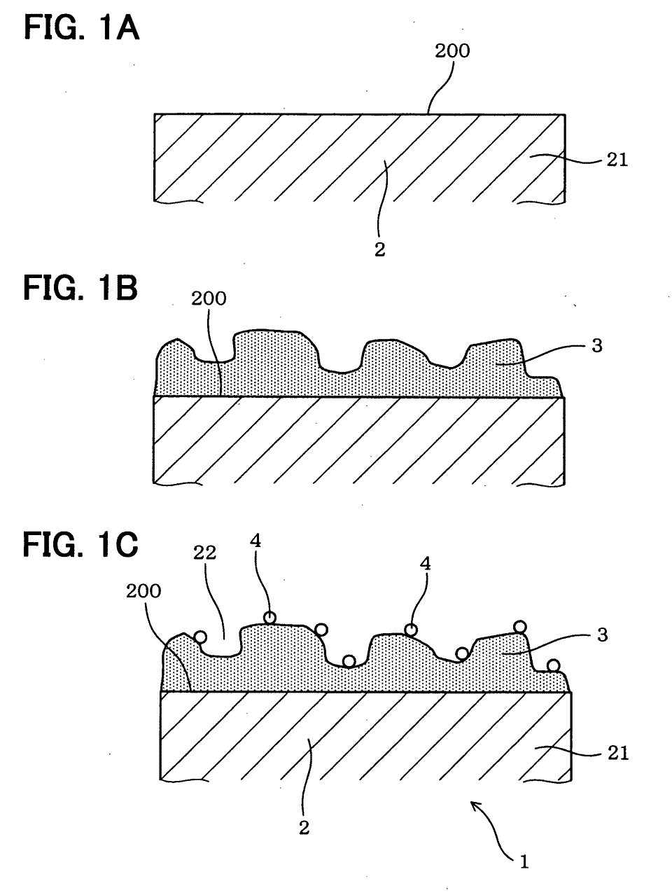

As shown in FIG. 1C, a gas cleaning catalyst unit 1 includes a base member 2, a supporting layer 3 and catalyst component 4. The supporting layer 3 is arranged on a surface of the base member 2, and is made of metal oxide. The catalyst component 4 is supported on a surface of the supporting layer 3, and is made of metal or metal oxide. The catalyst unit 1 is used for cleaning toxic component such as HC, CO or NOx, and the toxic component is contained in gas exhausted from an engine, for example.

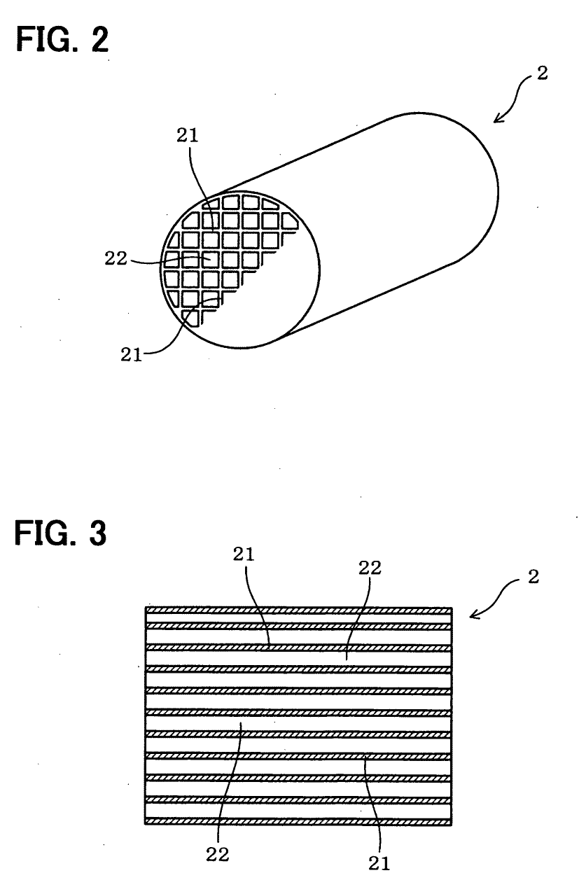

As shown in FIG. 2, the base member 2 has a honeycomb structure. The honeycomb structure has a polygon grid shaped porous wall 21, thereby plural cells 22 are defined in the base member 2. The cell 22 extends in an axis direction of the honeycomb structure. As shown in FIG. 3, the cell 22 defines a passage, and the exhausted gas flows in the passage. The base member 2 has a column shape having a height of 50 mm and a diameter of 30 mm, for example.

The base member 2 is made of cordierite ceramics, for example, and may correspond to a cylinder shaped porous member having multiple pores. The wall 21 has a rectangular grid shape, and the cell 22 has a rectangular cross-section.

As shown in FIG. 1C, the supporting layer 3 is arranged on a surface 200 of the wall 21 of the base member 2, and is made of ceria (CeO₂), for example. The catalyst component 4 is supported on the supporting layer 3, and is made of Pt particle having a diameter of about 0.5-1 nm. The catalyst unit 1 is produced through a supporting layer form process and a catalyst component support process.

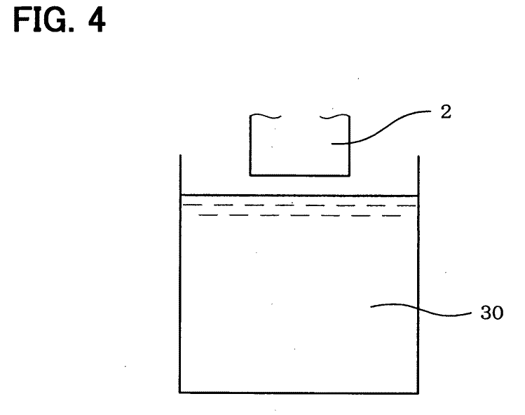

FIGS. 1A and 1B illustrate the supporting layer form process, in which the supporting layer 3 is formed on the surface 200 of the base member 2. Specifically, as shown in FIG. 4, the base member 2 is immersed in a support slurry 30. At this time, the base member 2 is coated with supporting particles contained in the support slurry 30, and the base member 2 coated with the supporting particles is fired. The support slurry 30 has a solvent and the supporting particles suspended in the solvent. The supporting particle is made of metal oxide such as ceria.

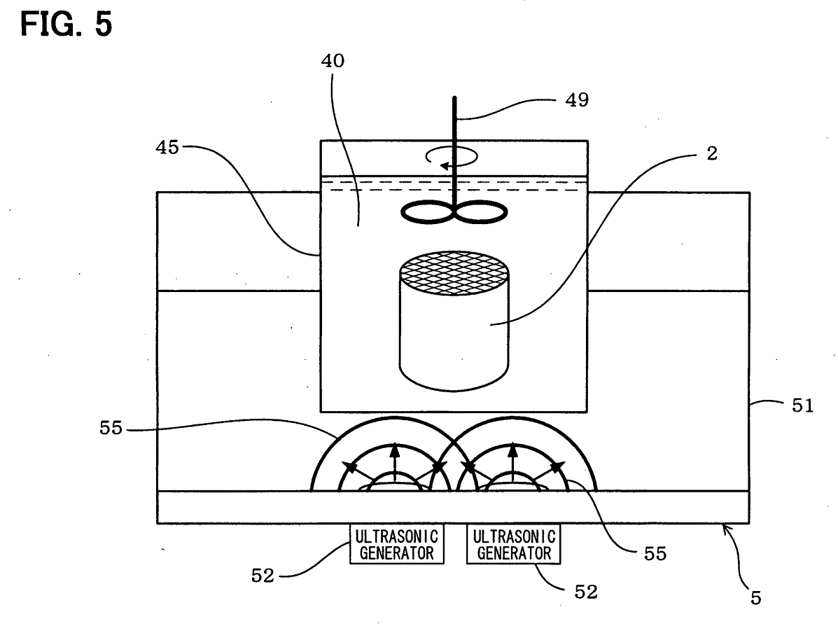

FIG. 5 illustrates the catalyst component support process. The base member 2 having the supporting layer 3 is immersed in a catalyst slurry 40, and ultrasonic wave 55 is radiated toward the catalyst slurry 40. Thus, the catalyst component 4 is supported by the supporting layer 3, as shown in FIG. 1C.

Catalyst precursor is suspended in the catalyst slurry 40. The catalyst slurry 40 has a solvent made of alcohol, and the precursor is suspended in the solvent. Further, a reducing agent may be added in the catalyst slurry 40, and the reducing agent is acted relative to a metal ion of the precursor.

A producing method of the catalyst unit 1 will be specifically described. The support slurry 30 is formed by dispersing the supporting particles in water. The supporting particle is made of CeO₂, and has an average particle diameter of 3 μm. Further, the base member 2 is prepared. The base member 2 is immersed in the support slurry 30, thereby the whole of the base member 2 is coated with the supporting particle of the support slurry 30 so as to have a uniform coating thickness.

The base member 2 coated with the supporting particle is fired for five hours at a temperature of 1000° C. Thus, the supporting layer 3 is formed to cover the surface 200 of the base member 2, as shown in FIG. 1B. The supporting layer 3 is made of ceria, and is arranged on the whole surface of the wall 21 of the base member 2. For example, the base member 2 is coated with ceria of 40 g/L, and the base member 2 has a specific surface area of 1.02 m²/g, due to the supporting layer 3.

Powdery catalyst precursor made of PtO₂ is added in solvent made of ethanol, and is dispersed by stirring. The catalyst precursor is added in a manner that Pt has an amount of 0.6 g. Thus, the catalyst slurry 40 is obtained, in which the catalyst precursor is dispersed in the solvent.

As shown in FIG. 5, the catalyst slurry 40 is filled in a container 45 having a stirrer 49, and the base member 2 having the supporting layer 3 is immersed in the catalyst slurry 40. Ultrasonic wave 55 is radiated to the catalyst slurry 40 by using an ultrasonic wave generator 5. For example, the generator 5 is a sono-reactor produced by Honda Electronics Co. Ltd. The generator 5 includes a tank 51 and an ultrasonic transducer 52. The tank 51 has a base face made of metal such as stainless steel, and the transducer 52 is arranged on the base face.

Specifically, as shown in FIG. 5, the catalyst slurry 40 is stirred by the stirrer 49, and the base member 2 is immersed in the stirred catalyst slurry 40. The container 45 having both of the base member 2 and the catalyst slurry 40 is further immersed in the tank 51 of the generator 5. A temperature of water in the tank 51 is set to be 25° C. When the generator 5 is activated, ultrasonic wave 55 is generated from the transducer 52. Thus, ultrasonic wave 55 is radiated to the catalyst slurry 40. A frequency of the ultrasonic wave 55 is set to be 20-30 kHz, and a radiation time is set to be one hour, for example.

Therefore, the catalyst precursor of the catalyst slurry 40 is reduced, and is deposited on the supporting layer 3 of the base member 2 as the catalyst component 4. As shown in FIG. 1C, the catalyst component 4 made of Pt particle is supported on the supporting layer 3. The catalyst unit 1 produced in the above method is defined as a first embodiment sample E1.

Further, second, third and fourth embodiment samples E2, E3, E4 of the catalyst unit 1 are produced by using catalyst slurry having compositions different from those of the sample E1.

The second sample E2 is produced by using a catalyst slurry having a solvent (water), catalyst precursor (PtCl₂), and reducing agent (diethanolamine). The catalyst precursor and the reducing agent are added and mixed in the solvent. Other points except for using this catalyst slurry are made similar to the sample E1. Diethanolamine is mixed in water to have a concentration of 0.01 wt % as the reducing agent.

The third sample E3 is produced by using a catalyst slurry having a solvent (water), catalyst precursor (PdCl₂), and reducing agent (diethanolamine). The catalyst precursor and the reducing agent are added and mixed in the solvent. Other points except for using this catalyst slurry are made similar to the sample E1. Diethanolamine is mixed in water to have a concentration of 0.01 wt % as the reducing agent, similarly to the sample E2.

The fourth sample E4 is produced by using a catalyst slurry having a solvent (water), catalyst precursor (Rh(NO₃)₃), and reducing agent (diethanolamine). The catalyst precursor and the reducing agent are added and mixed in the solvent. Other points except for using this catalyst slurry are made similar to the sample E1. Diethanolamine is mixed in water to have a concentration of 0.01 wt % as the reducing agent, similarly to the samples E2 and E3.

Further, five comparison samples C1, C2, C3, C4, C5 (hereinafter referred as C1-C5) of catalyst unit of comparison example are formed relative to the embodiment samples E1, E2, E3, E4 (hereinafter referred as E1-E4).

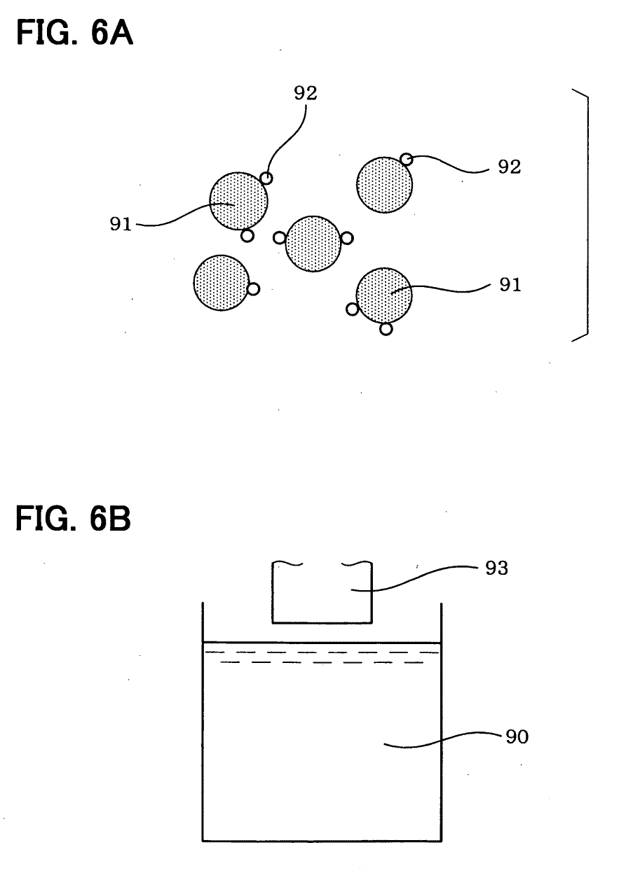

For producing the first comparison sample C1, a mix slurry is formed by mixing supporting particles (CeO₂) and catalyst precursor (chloroplatinic acid). The supporting particle has an average diameter of 3 μm. As shown in FIG. 6A, catalyst component 92 made of Pt is deposited on a surface of a supporting particle 91, when the mix slurry is fired at a temperature of 800° C.

A catalyst slurry 90 is formed by dispersing the supporting particle 91 having the catalyst component 92 in water. As shown in FIG. 6B, a base member 93 is immersed in the catalyst slurry 90. The base member 93 is a honeycomb structure, similarly to the embodiment sample E1. Thus, the base member 93 has a dip-coat with the supporting particle 91 having the catalyst component 92, and the dip-coated base member 93 is fired at a temperature of 500° C. Therefore, as shown in FIG. 8, a supporting layer 94 made of CeO₂ is formed on the base member 93, and the catalyst component 92 is supported on and in the supporting layer 94. The first comparison sample C1 may correspond to a comparison catalyst unit 9 of FIG. 8.

For producing the second comparison sample C2, a base member is immersed in a slurry having water and alumina particle dispersed in the water. The immersed base member is fired at a temperature of 1000° C. Thus, a supporting layer made of alumina is formed an a surface of a honeycomb structure of the base member. Similarly to the first comparison sample C1, a catalyst slurry is formed by dispersing the supporting particle having the catalyst component in water, and the base member having the supporting layer is immersed in the catalyst slurry. Thus, the supporting layer of the base member has a dip-coat with the supporting particle having the catalyst component. The dip-coated base member is fired, such that the second comparison sample C2 can be produced.

For producing the third comparison sample C3, a mix slurry is formed by mixing supporting particle (CeO₂), catalyst precursor (PtCl₂) and reducing agent (diethanolamine) in water. The supporting particle has an average diameter of 3 μm. At this time, the reducing agent is mixed in the water to have a concentration of 0.01 wt %. Further, as shown in FIG. 6A, catalyst component 92 made of Pt is reduced and deposited on a surface of a supporting particle 91, by radiating ultrasonic wave to the mix slurry.

Similarly to the first comparison sample C1, a catalyst slurry is formed by dispersing, the supporting particle having the catalyst component in water. A base member having a honeycomb structure is immersed in the catalyst slurry, thereby the base member has a dip-coat with the supporting particle having the catalyst component. The dip-coated base member is fired at a temperature of 500° C., such that the third comparison sample C3 can be produced.

For producing the fourth comparison sample C4, similarly to the third comparison sample C3, as shown in FIG. 6A, catalyst component 92 made of Pt is deposited on a surface of a supporting particle 91, by using ultrasonic wave. A catalyst slurry is formed by dispersing the supporting particle having the catalyst component in water.

Further, similarly to the second comparison sample C2, a supporting layer made of alumina is formed on a surface of a base member. The base member is immersed in the catalyst slurry, and the supporting particle having the catalyst component is dip-coated on the supporting layer of the base member. The dip-coated base member is fired at a temperature of 500° C., such that the fourth comparison sample C4 can be produced.

For producing the fifth comparison sample C5, similarly to the third comparison sample C3, as shown in FIG. 6A, catalyst component 92 made of Pt is deposited on a surface of a supporting particle 91, by using ultrasonic wave. A catalyst slurry is formed by dispersing the supporting particle having the catalyst component in water. Further, alumina particle is dispersed in the catalyst slurry. A base member having a honeycomb structure is immersed in the catalyst slurry, thereby the base member has a dip-coat with the supporting particle and the alumina particle. The dip-coated base member is fired at a temperature of 500° C., such that the fifth comparison sample C5 can be produced.

An amount of CeO₂, catalyst component or alumina is approximately the same among the samples E1, E2, E3, E4, C1, C2, C3, C4, C5 (hereinafter described as E1-C5).

Evaluation of gas cleaning performance is conducted relative to the samples E1-C5.

Particle diameter of catalyst component supported on the sample E1-C5 is measured after having a high temperature condition.

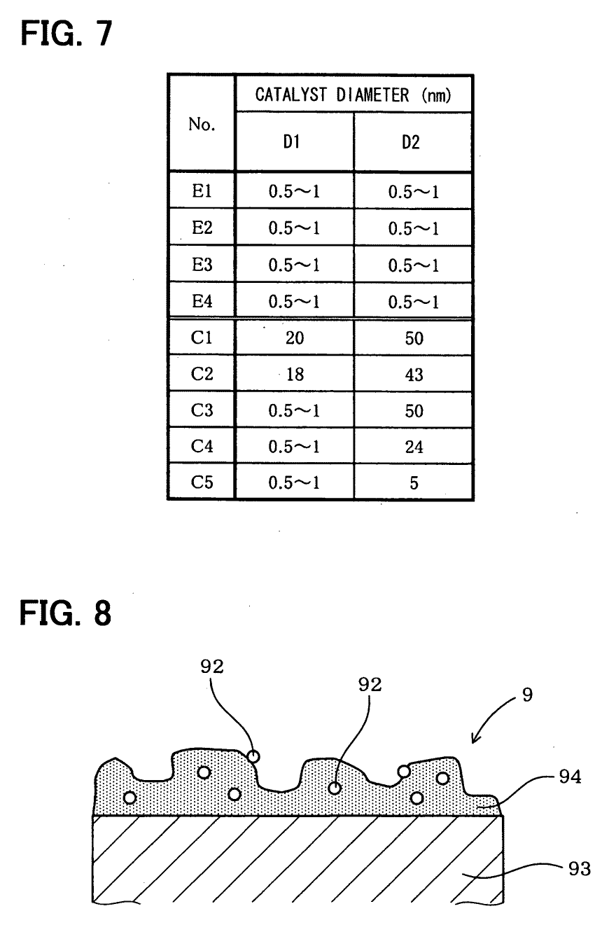

Specifically, the samples E1-C5 are heated at a temperature of 800° C. so as to make heating conditions uniform. The diameter is measured by measuring a surface area of catalyst component using a transmission electron microscope (TEM) observation and CO pulse method. In the CO pulse method, CO gas is continuously injected to catalyst particle, and an amount of CO adsorbed on the catalyst particle is measured. The particle diameter is calculated based on the CO adsorbed amount, a kind of catalyst metal, and an amount of metal contained in the catalyst particle. For example, the diameter is measured by using a full-automatic catalyst gas adsorption amount measuring machine R6015 produced by OHKURA RIKEN CO., LTD. The measurement results are shown in D1 of FIG. 7.

Further, diameter is similarly measured, after the samples E1-C5 are heated at a temperature of 950° C. The measurement results are shown in D2 of FIG. 7. As shown in D1 of FIG. 7, the catalyst diameter of the comparison sample C1 is 20 nm, and the catalyst diameter of the comparison sample C2 is 18 nm. Because the catalyst component of the comparison sample C1, C2 is supported by performing the firing, the catalyst component is flocculated by the firing, such that the catalyst diameter becomes relatively large. Further, based on the TEM observation result of the comparison sample C1, C2, most of the catalyst component 92 is buried in the supporting layer 94, as shown in FIG. 8.

In contrast, the catalyst diameter of the sample E1-E4, C3, C4, C5 is 0.5-1 nm. Because the catalyst component of the sample E1-E4, C3, C4, C5 is supported by using ultrasonic wave, the catalyst diameter becomes relatively small and minute. The catalyst particle can be restricted from being flocculated, due to micro-jet water stream formed by ultrasonic wave.

Because the catalyst diameter of 0.5-1 nm is under a detection limit of the transmission electron microscope, it is difficult to observe the catalyst component of the embodiment sample E1-E4. Therefore, whether the catalyst component 4 is buried in the supporting layer 3 or not cannot be determined by the TEM observation. In order to determine whether the catalyst component 4 is buried or not, a catalyst unit is formed in a manner that the catalyst diameter is enlarged to a level of 2 nm by using ultrasonic wave.

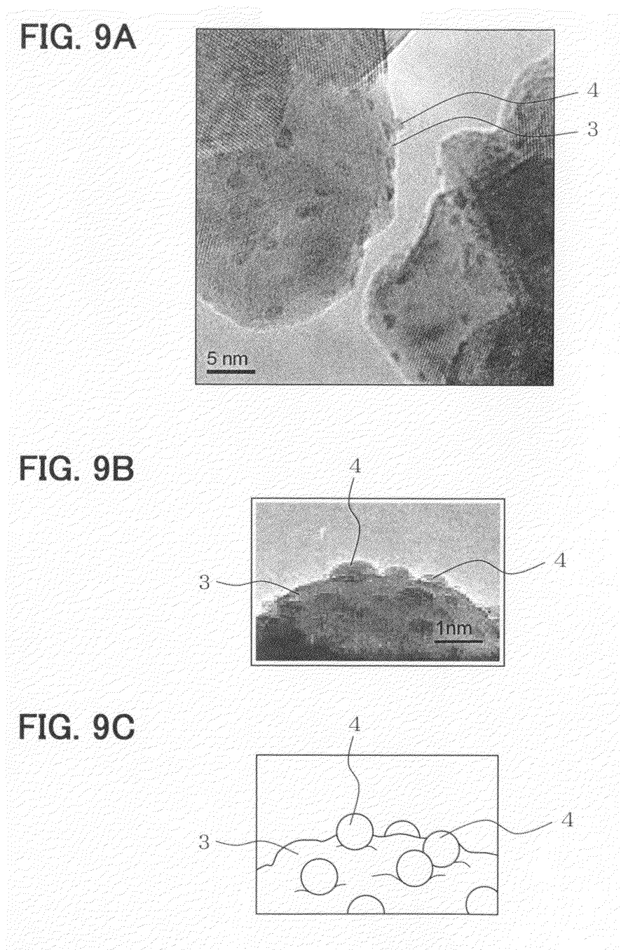

Specifically, a catalyst slurry is formed by adding catalyst precursor in ethanol solvent, in a manner that an amount of Pt becomes equal to 1.2 g. Other points are made similar to the embodiment sample E1. Thus, a TEM sample T is produced for performing a TEM observation. Result of the TEM observation relative to the sample T is shown in FIGS. 9A, 9B and 9C.

As shown in FIGS. 9A, 9B and 9C, catalyst component 4 of the sample T is supported on a surface of a supporting layer 3. That is, the catalyst component 4 is not buried in the supporting layer 3. Thus, the catalyst component 4 can be supported and deposited on the surface of the supporting layer 3 by using ultrasonic wave.

As shown in D2 of FIG. 7, the catalyst diameter of the comparison sample C1-C5 becomes large after heated at the temperature of 950° C., because the catalyst component is flocculated. In contrast, the flocculation of the catalyst component is not found relative to the embodiment sample E1-E4. The catalyst diameter of the embodiment sample E1-E4 is maintained to be small after heated at the temperature of 950° C.

Further, based on a TEM observation (not shown), the catalyst component of the comparison sample C2, C4, C5 is buried in the supporting layer made of alumina, because alumina is flocculated.

Gas cleaning performance is evaluated relative to the samples E1-C5. Specifically, the sample E1-C5 is arranged in a quartz glass tube. CO gas, propylene gas and NO gas are made to flow in the tube from an inlet side at a condition that an infrared image furnace has a temperature of 50-400° C.

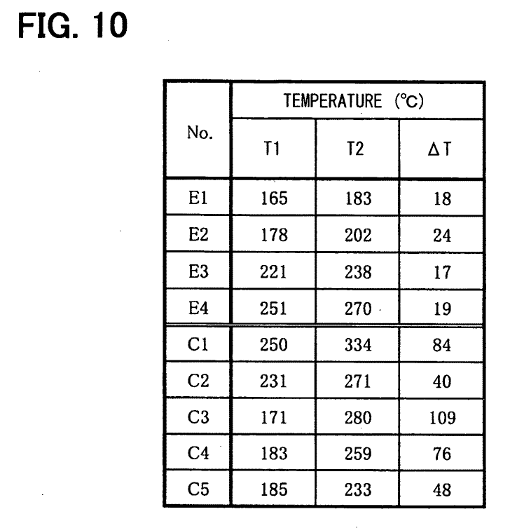

Amount and component of gas emitted from an outlet side of the tube is analyzed by using a gas chromatography. A cleaning temperature is defined as a temperature at which 50% of the CO gas, propylene gas and NO gas is cleaned. Measurement results of the cleaning temperature are shown in T1 of FIG. 10.

Further, the cleaning temperature is measured after the samples E1-C5 are left in the furnace having a temperature of 950° C. for 24 hours, in order to evaluate a stability at a higher temperature. Results for the stability evaluation are shown in T2 of FIG. 10, and an increasing of the cleaning temperature is calculated (ΔT=T2−T1) and the calculated results are shown in ΔT of FIG. 10.

As shown in T1 of FIG. 10, the cleaning temperature of the embodiment sample E1-E4 is low, compared with that of the comparison example C1-C5.

Therefore, the cleaning performance of the embodiment sample E1-E4 is higher than that of the comparison sample C1-C5. Further, as shown in T2 of FIG. 10, the cleaning performance of the embodiment sample E1-E4 can be maintained to be high after heated at the temperature of 950° C., compared with the comparison sample C1-C5. Therefore, high-temperature endurance performance of the embodiment sample E1-E4 is high.

According to the embodiment, the embodiment sample E1-E4 of the catalyst unit 1 can stably clean toxic component for a long time at a practical environment having a temperature of 950° C., for example. The catalyst unit 1 is produced by performing the supporting layer form process and the catalyst component support process. The supporting layer 3 is formed on the surface 200 of the base member 2 in advance, in the supporting layer form process. The base member 2 having the supporting layer 3 is immersed in the catalyst slurry 40, and ultrasonic wave 55 is radiated, in the catalyst component support process. Thus, the catalyst component 4 can be supported on the supporting layer 3.

Due to the ultrasonic wave, air bubble in the catalyst slurry 40 is broken by applying pressure, in the catalyst component support process. Therefore, the catalyst component 4 is solidly and strongly supported on the supporting layer 3 by using the applied pressure. Further, the catalyst component 4 can have a nanometer-order micro-particle state, or have a metal film state made of some atomic layers, for example.

Because ultrasonic wave is a compression wave, rapid pressure variation is generated in a minute area, when ultrasonic wave travels in liquid such as the catalyst slurry 40. At this time, if air bubble exists in the liquid, expansion and contraction of the air bubble are repeated by the pressure variation. Therefore, high temperature and high pressure field is formed inside of the air bubble, and the air bubble is broken. Thus, the high temperature and high pressure field is released outside of the air bubble. The high temperature and high pressure field may have a temperature of multi-thousands degree C., and may have a pressure of multi-hundreds atmospheric pressure. Further, a micro-jet water stream having a speed of multi-hundreds meter per second can be formed.

The catalyst component 4 can be made tightly contact with the supporting layer 3 by using high temperate and high pressure energy and the micro-jet water stream. Therefore, the catalyst component 4 has atomic state or cluster state made of dozens of atom, and is instantaneously pressed onto the supporting layer 3, due to the micro-jet water stream. Thus, the catalyst component 4 can be restricted from being flocculated, and can be solidly and strongly supported on the supporting layer 3 in nanometer-order.

Therefore, high temperature firing is unnecessary for supporting the catalyst component 4, and the catalyst component 4 can be restricted from being buried in the supporting layer 3. Thus, the catalyst unit 1 can stably clean toxic component for a long time at a practical environment.

The catalyst unit 1 is produced by performing the supporting layer form process and the catalyst component support process.

The catalyst unit 1 is used for eliminating toxic component such as HC, CO or NOx contained in gas exhausted from an engine, for example. The catalyst unit 1 may be arranged in a passage through which the exhausted gas passes.

The supporting layer 3 is formed on the surface 200 of the base member 2, and is made of metal oxide, in the supporting layer form process. At this time, the forming of the supporting layer 3 may include a forming of the support slurry 30 by making the support particle to be suspended in solvent. The support particle is made of metal oxide. Further, the base member 2 is immersed in the support slurry 30, and the base member 2 is fired after the immersing.

In this case, the supporting layer 4 can be easily formed on the surface 200 of the base member 2. The solvent used for dispersing the support particle may be liquid unable to react with the support particle or the base member 2. For example, the solvent may be made of water, such that producing cost can be reduced.

The firing of the base member 2 may be performed at a temperature equal to or higher than 800° C.

In this case, the surface of the base member 2 can be made smooth, and the catalyst component 4 can be restricted from being buried in the supporting layer 3. Therefore, the cleaning performance of the catalyst unit 1 can be improved. The firing temperature may be equal to or higher than 850° C., or the firing temperature may be equal to or higher than 900° C., if possible.

The forming of the supporting layer 3 may be performed in a manner that the supporting layer 3 has a surface area equal to or smaller than 50 m²/g.

In this case, the catalyst component 4 can be restricted from being buried in the supporting layer 3. Thus, the cleaning performance of the catalyst unit 1 can be improved.

The metal oxide defining the supporting layer 3 may be an oxide of at least one element selected from Mg, Al, Si, Ca, Sr, Ba, Sc, Ti, Fe, Y, Zr, Nb, Bi, Pr, La, Ce and Nd, or a solid solution having at least two elements selected from Mg, Al, Si, Ca, Sr, Ba, Sc, Ti, Fe, Y, Zr, Nb, Bi, Pr, La, Ce and Nd.

In this case, the base member 2 and the catalyst component 4 can be tightly contact with each other through the supporting layer 3.

Further, the metal oxide defining the supporting layer 3 may be an oxide of at least one element selected from Ce, Zr, La, Y, Fe, Bi, Pr, Ti, Mg and Nb, or a solid solution having at least two elements selected from Ce, Zr, La, Y, Fe, Bi, Pr, Ti, Mg and Nb.

In this case, the supporting layer 3 can absorb or emit oxygen based on an environmental oxygen concentration. That is, the oxygen concentration can be controlled by the supporting layer 3. Therefore, the supporting layer 3 can have catalyst-aiding performance. That is, the supporting layer 3 controls oxygen concentration of gas in a manner that the catalyst component 4 most effectively has the cleaning performance. For example, the metal oxide defining the supporting layer 3 may be a solid solution of CeO₂/ZrO₂.

Further, the metal oxide defining the supporting layer 3 may contain an element having high chemical adsorption energy relative to the catalyst component 4. If the catalyst component 4 is made of Pt, the element may be Mg, Ca, Sr, Ba, Sc, Y, La, Ti, Fe and the like, for example.

The base member 2 having the supporting layer 3 is immersed in the catalyst slurry 40, and ultrasonic wave 55 is radiated to the base member 2 immersed in the catalyst slurry 40. Thus, the catalyst component 4 is supported on the supporting layer 3.

The catalyst component 4 may be made of transition metal or transition metal oxide having an oxidizing or reducing ability relative to HC, CO and NOx.

In this case, the catalyst unit 1 can have higher cleaning performance relative to toxic component such as HC, CO and NOx contained in gas exhausted from a vehicle, for example.

Specifically, the catalyst component 4 may be a single element selected from Pt, Pd, Rh, Ir, Ru, Au, Ag, Re, Os, Co, Ni, Fe, Cu, Mn, Cr, V, Mo or W. Alternatively, the catalyst component 4 may be an oxide of an element selected from Pt, Pd, Rh, Ir, Ru, Au, Ag, Re, Os, Co, Ni, Fe, Cu, Mn, Cr, V, Mo or W. Alternatively, the catalyst component 4 may be a solid solution having at least two elements selected from Pt, Pd, Rh, Ir, Ru, Au, Ag, Re, Os, Co, Ni, Fe, Cu, Mn, Cr, V, Mo and W.

The solvent used for dispersing the catalyst component 4 may be liquid unable to react with the catalyst component 4, the supporting layer 3 or the base member 2. For example, the solvent may be water, such that producing cost can be reduced.

The catalyst component 4 is contained in the catalyst slurry 40 as a form of catalyst precursor, and the catalyst precursor is made of a derivative of metal oxide, metal salt or organometallic complex. The catalyst precursor is dispersed in the solvent made of alcohol. Alternatively, the catalyst slurry 40 may contain reducing agent to be acted for metal ion of the catalyst precursor.

In this case, the catalyst precursor is reduced and deposited on the supporting layer 3. Thus, the catalyst component 4 can have micro-particle state.

When the catalyst precursor and the alcohol solvent are used in a combination, the alcohol solvent reduces the metal ion of the catalyst precursor. Therefore, the catalyst precursor is reduced by alcohol, and the catalyst component 4 having the micro-particle state can be deposited on the supporting layer 3. The catalyst component 4 having the micro-particle sate is instantaneously pressed onto the supporting layer 3, due to high temperate and high pressure energy of ultrasonic wave. Further, due to the micro-jet water stream, the catalyst component 4 can be made tightly contact with the supporting layer 3, in a state that the catalyst component 4 has atomic state or cluster state made of dozens of atom. Therefore, the catalyst component 4 can be restricted from being flocculated, and can be solidly and strongly supported on the supporting layer 3 in nanometer-order. Thus, high temperature firing is unnecessary for supporting the catalyst component 4, and the catalyst component 4 can be restricted from being buried in the supporting layer 3. The alcohol may be ethanol or propanol, for example.

Further, when the catalyst precursor and the reducing agent are used in a combination, the reducing agent reduces the catalyst precursor, and the catalyst component 4 having the micro-particle state can be deposited on the supporting layer 3. Therefore, the catalyst component 4 can be restricted from being flocculated, and can be solidly and strongly supported on the supporting layer 3 in nanometer-order. Thus, high temperature firing is unnecessary, and the catalyst component 4 can be restricted from being buried in the supporting layer 3.

The catalyst precursor may be made of metal oxide, metal salt, organometallic complex, or a derivative of metal oxide, metal salt or organometallic complex. Similarly to the catalyst component 4, the catalyst precursor may contain at least one metal component selected from Pt, Pd, Rh, Ir, Ru, Au, Ag, Re, Os, Co, Ni, Fe, Cu, Mn, Cr, V, Mo or W. The catalyst precursor is reduced by the reducing agent, and the catalyst component 4 made of the selected metal can be deposited.

If the catalyst component 4 is made of Pt, the catalyst precursor may be metal oxide such as platinic acid, metal chloride such as platinum chloride, metal ammonium salt such as tetraammine platinum dichloride, or metal nitrate salt such as diammine dinitro platinum complex, for example.

The reducing agent is made of at least one of amine, sugar, aldehyde, carboxylic acid, or polymer surface-active agent.

In this case, the catalyst precursor can be sufficiently reduced and deposited in the catalyst component support process.

Specifically, the amine may be diethanolamine. The sugar may be sucrose. The polymer surface-active agent may be polyethyleneglycol or sodium dodecyl sulfate.

The reducing agent may be added into the catalyst slurry at a concentration of 0.01-10 wt %.

The diameter of the catalyst particle 4 can be controlled by controlling the concentration of the reducing agent. When the reducing agent has the concentration in a range of 0.01-10 wt %, the catalyst component 4 can have a diameter equal to or smaller than 10 nm, for example. Thus, the catalyst component 4 can have high catalyst activity.

When the concentration of the reducing agent is lower than 0.01 wt %, the catalyst precursor may not sufficiently be reduced. In this case, the catalyst activity may be lowered. In contrast, when the concentration of the reducing agent is higher than 10 wt %, the diameter of the catalyst particle 4 may become too large. In this case, the catalyst activity may be lowered, because the specific surface area is reduced.

The radiating of ultrasonic wave may be performed with a frequency range 20-300 kHz.

When the frequency is smaller than 20 kHz, the catalyst precursor may not sufficiently be reduced. In this case, the catalyst activity may be lowered. In contrast, when the frequency is higher than 300 kHz, it may be difficult to deposit the catalyst component 4 on the surface of the supporting layer 3. In this case, the catalyst activity may be lowered.

Further, ultrasonic wave having higher frequency may be used for the catalyst component 4 or the catalyst precursor dissolved in liquid phase. Ultrasonic wave having lower frequency may be used for the catalyst component 4 or the catalyst precursor unable to be dissolved in the liquid phase.

The method of producing the catalyst unit 1 may further include a forming of a promoter slurry by dispersing promoter particle in a solvent before the forming of the catalyst slurry. The base metal 2 having the supporting layer 3 is immersed in the promoter slurry, and the immersed base metal is heated, such that the promoter particle is supported on the supporting layer 4. The promoter particle is made of an oxide of element selected from Ce, Zr, La, Y, Fe, Bi, Pr, Ti, Mg and Nb, or is made of a solid solution having at least two elements selected from Ce, Zr, La, Y, Fe, Bi, Pr, Ti, Mg and Nb.

In this case, the promoter particle supported on the supporting layer 3 can control oxygen concentration, and the catalyst component 4 can be supported on the supporting layer 3 and the promoter particle. Therefore, the oxygen concentration can be controlled by the promoter particle, and the catalyst component 4 can clean toxic component in the optimum oxygen concentration. Thus, the catalyst unit 1 can have higher cleaning performance. Further, in this case, the catalyst unit 1 can have higher cleaning performance, even when the supporting layer 3 is not made of the metal oxide having the catalyst-aiding performance.

The base member 2 is made of honeycomb structure, and the honeycomb structure includes the porous wall 21 having the polygon grid-shape. The wall 21 defines the plural cells 22 in the honeycomb structure, and the cell 22 extends in an axis direction of the honeycomb structure.

In this case, the supporting layer 3 and the catalyst component 4 are formed on the wall 21. Therefore, when the exhausted gas passes through the cell 22, the gas can be effectively cleaned.

The honeycomb structure may be made of cordierite, SiC, alumina, aluminum titanate, zeorite, or SiO₂.

Changes and modifications are to be understood as being within the scope of the present invention as defined by the appended claims.

What is claimed is:

1. A method of producing a gas cleaning catalyst unit comprising:
forming a supporting layer made of metal oxide on a surface of a base member;
forming a catalyst slurry by making catalyst component to be suspended in a solvent;
immersing the base member having the supporting layer in the catalyst slurry; and
radiating ultrasonic wave to the base member immersed in the catalyst slurry, such that the catalyst component is supported on the supporting layer.

2. The producing method according to claim 1, wherein the forming of the supporting layer includes:
forming a support slurry by making support particles made of the metal oxide to be suspended in a solvent,;
immersing the base member in the support slurry; and
firing the base member after the base member is immersed in the support slurry.

3. The producing method according to claim 2, wherein
the firing of the base member is performed at a temperature equal to or higher than 800° C.

4. The producing method according to claim 1, wherein
the forming of the supporting layer is performed in a manner that the supporting layer has a surface area equal to or smaller than 50 m²/g.

5. The producing method according to claim 1, wherein
the metal oxide defining the supporting layer is an oxide of at least one element selected from Mg, Al, Si, Ca, Sr, Ba, Sc, Ti, Fe, Y, Zr, Nb, Bi, Pr, La, Ce and Nd, or is a solid solution having at least two elements selected from Mg, Al, Si, Ca, Sr, Ba, Sc, Ti, Fe, Y, Zr, Nb, Bi, Pr, La, Ce and Nd.

6. The producing method according to claim 1, wherein
the catalyst component is made of transition metal or transition metal oxide having an oxidizing or reducing ability relative to HC, CO and NOx.

7. The producing method according to claim 1, wherein
the catalyst component is made of metal oxide, metal salt, organometallic complex, or catalyst precursor made of a derivative of the metal oxide, the metal salt, or the organometallic complex,
the catalyst slurry has the catalyst precursor dispersed in the solvent, and
the solvent is made of alcohol.

8. The producing method according to claim 1, wherein
the catalyst component is made of metal oxide, metal salt, organometallic complex, or catalyst precursor made of a derivative of the metal oxide, the metal salt, or the organometallic complex,
the catalyst slurry has the catalyst precursor in the solvent, and
the catalyst slurry further has a reducing agent to reduce a metal ion of the catalyst precursor.

9. The producing method according to claim 8, wherein
the reducing agent is made of at least one of amine, sugar, aldehyde, carboxylic acid, or polymer surface-active agent.

10. The producing method according to claim 8, wherein
the reducing agent is added into the catalyst slurry at a concentration of 0.01-10 wt %.

11. The producing method according to claim 1, wherein the radiating of ultrasonic wave is performed with a frequency range 20-300 kHz.

12. The producing method according to claim 1, further comprising:
forming a promoter slurry by dispersing promoter particle in a solvent, before the base member is immersed in the catalyst slurry;
immersing the base metal having the supporting layer in the promoter slurry; and
heating the base metal immersed in the promoter slurry, such that the promoter particle is supported on the supporting layer, wherein
the promoter particle is made of an oxide of element selected from Ce, Zr, La, Y, Fe, Bi, Pr, Mg and Nb, or is made of a solid solution having at least two elements selected from Ce, Zr, La, Y, Fe, Bi, Pr, Ti, Mg and Nb.

13. The producing method according to claim 1, wherein
the base member is made of a honeycomb structure,
the honeycomb structure includes a porous wall having a polygon grid shape,
the wall defines plural cells in the honeycomb structure, and
the cell extends in an axis direction of the honeycomb structure.
